(19) United States
(12) Patent Application Publication
(10) Pub. No.: US 2026/0124534 A1
(43) Pub. Date: May 7, 2026

(54) METHOD AND DEVICE FOR INTERACTION IN VIRTUAL SCENE, ELECTRONIC DEVICE, STORAGE MEDIUM, AND PROGRAM PRODUCT

(71) Applicant: Hangzhou Pawprint Interactive Entertainment Technology Co., Ltd., Hangzhou (CN)

(72) Inventor: Yingwu ZHONG, Hangzhou (CN)

(21) Appl. No.: 19/329,233

(22) Filed: Sep. 15, 2025

(30) Foreign Application Priority Data
Nov. 4, 2024 (CN) 202411566596.1

(51) Int. Cl. A63F 13/50; A63F 13/25

(52) U.S. Cl. CPC A63F 13/50; A63F 13/25

(57) ABSTRACT

A method and device for interaction in a virtual scene, an electronic device, a computer-readable storage medium, and a computer program product are provided. The method includes that: a player character is displayed in a virtual scene; the form of the player character is controlled to be transformed into a first virtual pet in response to the transformation command for the player character; at least one second virtual pet of the same kind as the first virtual pet is displayed; and the first virtual pet is controlled to interact with the second virtual pet in response to the interaction command for the first virtual pet.

### CROSS-REFERENCE TO RELATED APPLICATION

This application claims priority to Chinese Patent Application No. 202411566596.1 filed on November 4, 2024, the entire content of which is incorporated herein by reference in its entirety.

### BACKGROUND

In the related games, the user can acquire a pet in the game scene, and then control the acquired pet to follow and perform activities alongside the player character controlled by the user. However, such an interaction mode is not only too simplistic, but also reduces the efficiency of human-computer interaction in the game.

### SUMMARY

The present disclosure relates to the technical field of the Internet, and more particularly relates to a method and apparatus for interaction in virtual scene, an electronic device, a computer-readable storage medium, and a computer program product.

An embodiment of the present disclosure provides a method for interaction in a virtual scene, which includes the following operations.

A player character is displayed in virtual scenes.

In response to a transformation command for the player character, a form of the player character is controlled to be transformed into a first virtual pet.

At least one second virtual pet of the same kind as the first virtual pet is displayed.

In response to an interaction command for the first virtual pet, the first virtual pet is controlled to interact with the at least one second virtual pet.

An embodiment of the present disclosure provides a device for interaction in a virtual scene, which includes a processor; and a memory configured to store a computer program executable for the processor. The processor is configured to:

display a player character in a virtual scene;

in response to a transformation command for the player character, control a form of the player character to be transformed into a first virtual pet;

display at least one second virtual pet of the same kind as the first virtual pet; and

in response to an interaction command for the first virtual pet, control the first virtual pet to interact with the at least one second virtual pet.

An embodiment of the present disclosure provides computer-readable storage medium having stored thereon a computer-executable instruction or a computer program that, when executed by a processor, implement the method for interaction in the virtual scene provided by the embodiments of the present disclosure. The method includes the following operations.

A player character is displayed in virtual scenes.

In response to a transformation command for the player character, a form of the player character is controlled to be transformed into a first virtual pet.

At least one second virtual pet of the same kind as the first virtual pet is displayed.

In response to an interaction command for the first virtual pet, the first virtual pet is controlled to interact with the at least one second virtual pet.

### BRIEF DESCRIPTION OF THE DRAWINGS

FIG. 1 is a schematic diagram of an architecture of an interaction system 100 in a virtual scene provided by an embodiment of the present disclosure.

FIG. 2 is a structural schematic diagram of an electronic device provided by an embodiment of the present disclosure.

FIG. 3 is a flowchart of a method for interaction in the virtual scene provided by an embodiment of the present disclosure.

FIG. 4 is a schematic diagram of a player character and a first virtual pet provided by an embodiment of the present disclosure.

FIG. 5A-FIG. 5C are schematic diagrams of a process of transforming a form of the player character into the first virtual pet provided by an embodiment of the present disclosure.

FIG. 6A-FIG. 6C are schematic diagrams of a process of fusing and forming the first virtual pet through the player character provided by an embodiment of the present disclosure.

FIG. 7 is a schematic diagram of the player character located at a target position provided by an embodiment of the present disclosure.

FIG. 8A-FIG. 8B are schematic diagrams of a process of switching the control from the first virtual pet to target other virtual pets provided by an embodiment of the present disclosure.

FIG. 9 is a schematic diagram of a summoning control provided by an embodiment of the present disclosure.

FIG. 10 is a schematic diagram of a summoning special effect provided by an embodiment of the present disclosure.

FIG. 11A-FIG. 11B are schematic diagrams of patterns at associated positions provided by an embodiment of the present disclosure.

FIG. 12 is a schematic diagram of a process of delivering an interaction task provided by an embodiment of the present disclosure.

FIG. 13 is a schematic diagram of communication between the first virtual pet and the second virtual pet provided by an embodiment of the present disclosure.

FIG. 14 is a flowchart of a method for interaction in virtual scene provided by an embodiment of the present disclosure.

### DETAILED DESCRIPTION

In order to make the purposes, technical solutions and advantages of the present disclosure clearer, the present disclosure will be described in further detail below with reference to the accompanying drawings. The described embodiments should not be regarded as a limitation of the disclosure. All other embodiments obtained by those of ordinary skilled in the art without making any creative effort fall within the scope of protection of the present disclosure.

In the following description, reference is made to "some embodiments", which describes a subset of all possible embodiments, but it is to be understood that "some embodiments" may be a same subset or different subsets of all possible embodiments, and may be combined with each other without conflict.

In the following description, reference to the terms "first, second, and third" is merely to distinguish similar objects and do not represent a specific ordering for the objects. It is to be understood that "first, second, and third" in a specific order or sequence may be interchanged where permitted, to enable the embodiments of the disclosure described herein to be implemented in an order other than that illustrated or described herein.

Unless otherwise defined, all technical and scientific terms used herein have the same meaning as commonly understood by those skilled in the art of the present disclosure. The terms used herein are intended solely for the purpose of describing the embodiments of the present disclosure, and are not intended to limit the disclosure.

Before providing a further detailed descriptions of the embodiments of the present disclosure, the nouns and terms involved in the embodiments of the present disclosure will be described. The nouns and terms involved in the embodiments of the present disclosure are applicable to the following explanations.

1) In response to: which is used to indicate a condition or state on which the performed operation depends. When the dependent condition or state is satisfied, the performed one or more operations may be performed in real time or with a preset delay. Unless otherwise specified, there is no limitation on the order of execution of the performed multiple operations.

2) Client (also called as user side): which refers to an application that provides local services to users and corresponds to the server. Except for certain applications that can only run locally, the client is generally installed on the terminal and requires coordination with a server to operate, that is, the client relies on corresponding servers and service programs in the network to provide corresponding services. In this way, a specific communication connection between the client and the server must be established to ensure the normal operation of the application, such as a virtual scene client (such as game client) and a video client.

3) Virtual scene: which is a virtual scene displayed (or provided) by the application when running on the terminal. The virtual scene may be a simulated environment of the real world, a semi-simulated and semi-fictitious virtual environment, or a purely fictitious virtual environment. The virtual scene may be any one of a two-dimensional virtual scene, a 2.5-dimensional virtual scene, or a three-dimensional virtual scene.

For example, the virtual scene may include sky, land, ocean, and the like. The land may include environmental elements such as deserts and cities. The user may control the player character to perform activities in the virtual scene, and the activities include, but are not limited to, at least one of adjusting a body posture, crawling, walking, running, riding, jumping, driving, picking up, shooting, attacking, or throwing. The virtual scene may be a virtual scene displayed from a first-person perspective (e.g., playing a player character in a game from the user's own perspective), from a third-person perspective (for example, the user follows the player character in the game to play the game), or from a bird's-eye perspective, and an arbitrarily switch between these perspective may be performed.

4) Player character: which refer to various human and object representations that may interact in the virtual scene, or a movable object in the virtual scene. The movable object may be a virtual character, a virtual animal, an animated character, or the like, for example, a character, an animal, a plant, an oil drum, a wall, a stone, a vehicle, or the like displayed in the virtual scene. The player character may be a virtual avatar representing the user in the virtual scene. The virtual scene may include multiple player characters, and each player character has its own shape and volume in the virtual scene, occupying a part of the space in the virtual scene.

For example, the player character may be: a user character controlled by an operation on the client, an Artificial Intelligence (AI) set for battle in a virtual scene through training, or a non-user character (NPC) set for interaction in a virtual scene. The number of player characters participating in the interaction in the virtual scene may be preset, or may be dynamically determined based on the number of clients participating in the interaction.

5) Virtual pet: which refer to various human and object representations that may interact in the virtual scene. The virtual pat may be obtained through trading by the user or captured by the player character controlled by the user. The virtual pat may be placed in the user's backpack, follow the player character in the virtual scene, or move freely. The virtual pat may be controlled by the user or NPCs.

6) Third-person perspective: which refers to the viewpoint in the game where the in-game camera is located at a certain distance behind the player character, allowing the character and all combat elements in a certain surrounding environment to be seen in the picture.

7) First-person perspective: which refers to the viewpoint in the game where the in-game camera is located at the eye level of the player character, allowing the character's body and all combat elements in a certain surrounding environment to be seen in the picture.

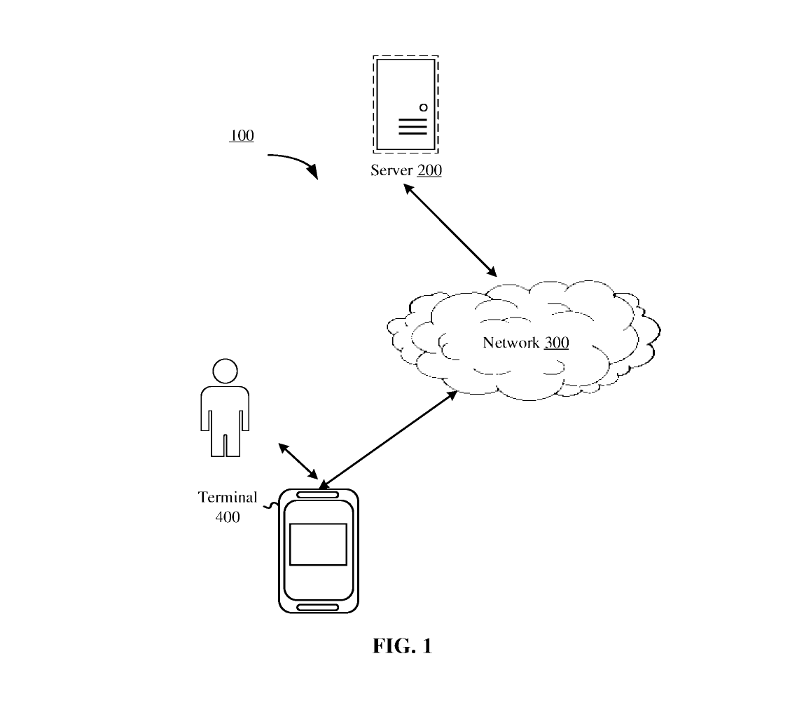

Referring to FIG. 1, FIG. 1 is a schematic diagram of an architecture of an interaction system 100 in a virtual scene provided by an embodiment of the present disclosure. A terminal (exemplarily illustrating a terminal 400) is connected to a server 200 through a network 300. The network 300 may be a wide area network or a local area network, or a combination thereof, and data transmission is realized using a wireless or wired link.

The server 200 is configured to transmit display data of the virtual scene to the terminal 400.

The terminal 400 is configured to: receive display data of the virtual scene and display the virtual scene based on the display data: display the player character in the virtual scene, the player character possessing a first virtual pet; in response to the transformation command for the player character, control the form of the player character to be transformed into the first virtual pet; displaying at least one second virtual pet, the second virtual pet being of the same kind as the first virtual pet; and in response to the interaction command for the first virtual pet, control the first virtual pet to interact with the second virtual pet.

In some embodiments, the server 200 may be an independent physical server, a server cluster or a business system composed of multiple physical servers, or a cloud server that provides basic cloud computing services such as cloud service, cloud database, cloud computing, cloud function, cloud storage, network service, cloud communication, middleware service, domain name service, security service, content delivery network (CDN), and big data and artificial intelligence platform. The terminal 400 may be a smartphone, a tablet computer, a notebook computer, a desktop computer, set-top box, smart voice interaction device, smart home appliance, virtual reality device, in-vehicle terminal, aircraft, portable music player, personal digital assistant, dedicated messaging device, portable gaming device, a smart speaker, a smart watch or the like, but it is not limited thereto. The terminal and server may be directly or indirectly connected through wired or wireless communication manners, which is not limited in the embodiments of the disclosure.

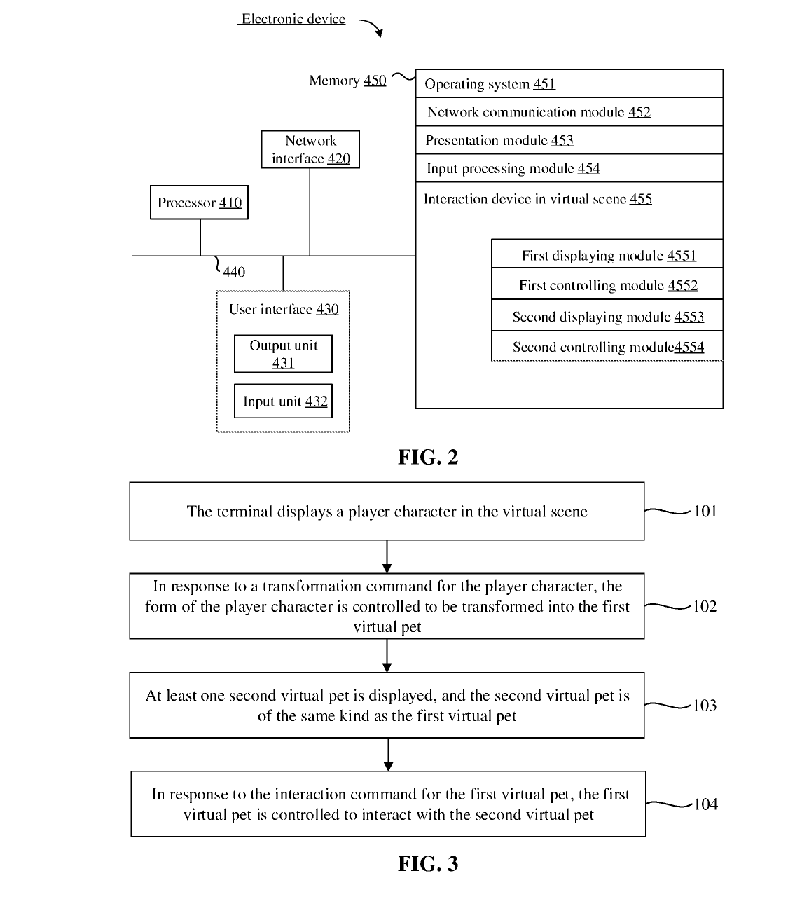

Next, an electronic device that implements the method for interaction in the virtual scene provided by the embodiment of the present disclosure will be described. Referring to FIG. 2, FIG. 2 is a structural schematic diagram of an electronic device provided by an embodiment of the present disclosure, and the electronic device may be a server or a terminal. Taking the electronic device as the terminal illustrated in FIG. 1 as an example, the electronic device illustrated in FIG. 2 includes at least one processor 410, a memory 450, at least one network interface 420, and a user interface 430. The various components in the terminal 400 are coupled together via a bus system 440. It will be appreciated that the bus system 440 is configured to implement the connection and communication between these components. The bus system 440 includes a power bus, a control bus, and a status signal bus in addition to a data bus. However, for clarity of illustration, various buses are designated as bus system 440 in FIG. 2.

The processor 410 may be an integrated circuit chip with signal processing capabilities, such as a general-purpose processor, a Digital Signal Processor (DSP), or other programmable logic device, a discrete gate or transistor logic device, a discrete hardware component, or the like. Among these, the general-purpose processor may be a microprocessor or any conventional processor, or the like.

The user interface 430 includes one or more output units 431 that enable display of media content, including one or more speakers and/or one or more visual display screens. The user interface 430 also includes one or more input units 432, including user interface components that facilitate user input, such as a keyboard, a mouse, a microphone, a touchscreen display, a camera, other input buttons and controls.

The memory 450 may be removable, non-removable, or a combination thereof. Exemplary hardware devices include a solid state memory, a hard disk drive, an optical disk drive, and the like. The memory 450 optionally includes one or more storage devices that are physically located remotely from the processor 410.

The memory 450 includes a volatile memory or a non-volatile memory, or may include both volatile and non-volatile memory. The non-volatile memory may be a Read Only Memory (ROM), and the volatile memory may be a Random Access Memory (RAM). The memory 450 described in the embodiments of the present disclosure is intended to include any suitable type of memory.

In some embodiments, the memory 450 is capable of storing data to support various operations, examples of the data include programs, modules, and data structures, or subsets or supersets thereof, as illustrated below.

An operating system 451 includes system programs for handling various basic system services and performing hardware-related tasks, such as a framework layer, a core library layer, a driver layer, and the like, enabling the implementation of various basic services and the processing of hardware-based tasks.

A network communication module 452 is configured to access other electronic devices via one or more (wired or wireless) network interfaces 420. Exemplary network interfaces 420 include: Bluetooth, wireless fidelity (WiFi), and Universal Serial Bus (USB), etc.

A presentation module 453 is configured to enable presentation of information (e.g., a user interface for operating peripheral devices and displaying content and information) via one or more output units 431 (e.g., a display screen, speakers, etc.) associated with the user interface 430.

An input processing module 454 is configured to detect one or more user inputs or interactions from one of the one or more input units 432 and to translate the detected inputs or interactions.

In some embodiments, the device provided by the embodiment of the present disclosure may be implemented by software. FIG. 2 illustrates an interaction device 455 in the virtual scene stored in the memory 450, which may be software in the form of programs and plug-ins. The interaction device 455 includes the following software modules: a first displaying module 4551, a first controlling module 4552, a second displaying module 4553, and a second controlling module 4554. These modules are logical and can be arbitrarily combined or further subdivided according to the implemented functions. The functions of the respective modules will be described below.

In other embodiments, the device provided by the embodiment of the present disclosure may be implemented in a hardware manner. As an example, the interaction device in the virtual scene provided by the embodiment of the present disclosure may be a processor in the form of a hardware decoding processor, which is programmed to perform the interaction method in the virtual scene provided by the embodiment of the present disclosure.

In some embodiments, the terminal or the server may implement the interaction method in the virtual scene provided by the embodiment of the present disclosure by running a computer program. For example, a computer program may be a native program or software module in an operating system. The computer program may also be a Native Application (APP) (i.e., a local client), that is, a program that needs to be installed in the operating system to run, such as an instant messaging APP and a web browser APP. The computer program may also be a mini-program, that is, a program that may run once downloaded into the browser environment. The computer program may also be a mini-program that may be embedded in any APP. In summary, the computer program described above may be any form of client, module, or plug-in.

Based on the above description of the interaction system and the electronic device in the virtual scene provided by the embodiment of the present disclosure, the interaction method in the virtual scene provided by the embodiment of the present disclosure will be described below. In actual implementation, the interaction method in the virtual scene provided by the embodiment of the present disclosure may be implemented independently by the terminal or the server, or may be implemented by the terminal and the server in cooperation. For example, the terminal 400 in FIG. 1 independently performs the interaction method in the virtual scene provided by the embodiment of the present disclosure. Referring to FIG. 3, FIG. 3 is a flowchart of a method for interaction in the virtual scene provided by an embodiment of the present disclosure. The explanation will be described in conjunction with the operations illustrated in FIG. 3.

In operation 101, the terminal displays a player character in the virtual scene.

In actual implementation, an application that supports virtual scenes is installed on the terminal. The application may be any one of a multiplayer online role-playing game, a first-person shooter game, a third-person shooter game, a multiplayer online battle arena game, a virtual reality application, a three-dimensional map program, or a multiplayer survival shooter game. The user may engage in game sessions via the terminal in the application, and when the user opens the application on the terminal and the terminal runs the application, the terminal displays a page of a virtual scene. Here, the virtual scene is obtained by observing the virtual scene from the first-person perspective or from the third-person perspective. The virtual scene includes a player character, which may be controlled by the current player or by other players (teammates) belonging to the same group as the current player.

It should be noted that the form of the player character is preset, and may be, for example, a human form, an animal form, a plant form, a gas form, or the like, but the embodiment of the present disclosure is not limited thereto.

In operation 102: in response to a transformation command for the player character, the form of the player character is controlled to be transformed into the first virtual pet.

It should be noted that “the form of the player character is controlled to be transformed into the first virtual pet” means that the player character is transformed into the first virtual pet, that is, shifting control from the player character to the first virtual pet. Herein, the first virtual pet may be possessed by the player character, that is, the first virtual pet may be previously acquired by the player, for example, captured in a virtual scene, purchased from an in-game store, or received it as a gift, which is not limited in the embodiments of the present disclosure. When the player character is displayed in the virtual scene, the first virtual pet possessed by the player character may be displayed in the virtual scene, or may not be displayed in the virtual scene (for example, in the backpack of the player character). Here, the virtual pet may be in the form of an animal, a plant, or the like, which is not limited in the embodiments of the present disclosure.

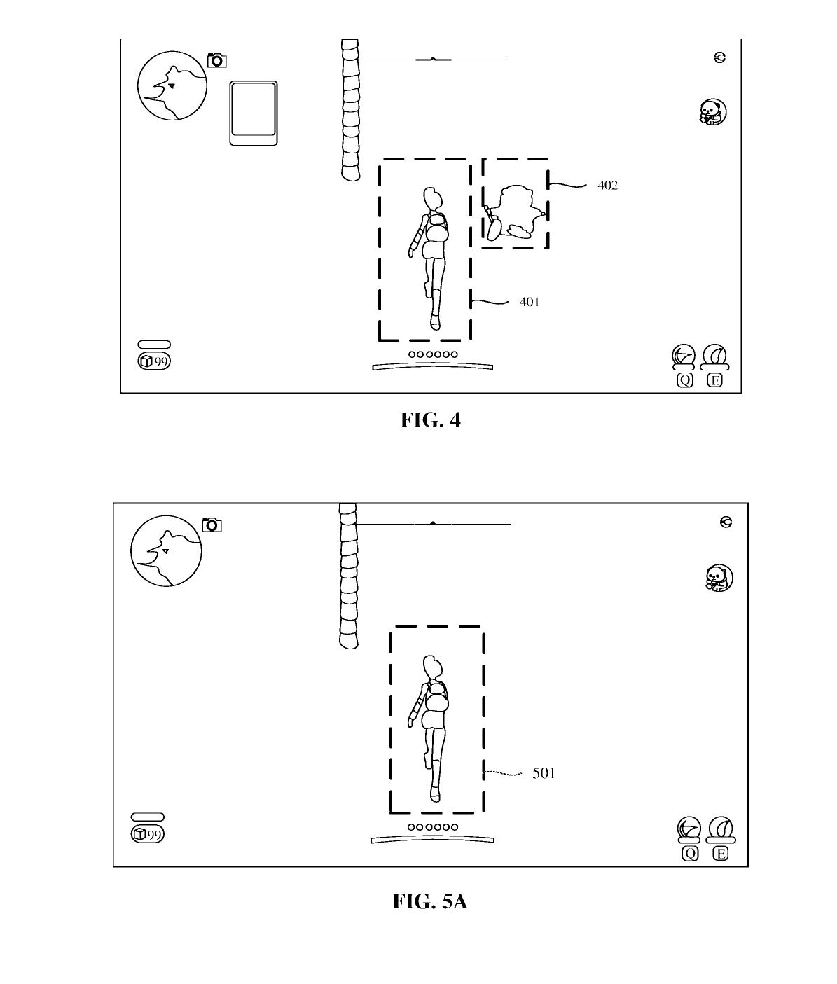

For example, referring to FIG. 4, FIG. 4 is a schematic diagram of a player character and a first virtual pet provided by an embodiment of the present disclosure. Based on FIG. 4, FIG. 4 illustrates an interface where the player character and the first virtual pet possessed by the player character are displayed together in the virtual scene; herein, a dashed box 401 indicates the player character, and a dashed box 402 indicates the first virtual pet possessed by the player character.

Alternatively, the first virtual pet is not possessed by the player character, for example, the first virtual pet is one encountered when the player character moves in a virtual scene, or is randomly determined when a transformation command for the player character is triggered, which is not limited in the embodiment of the present disclosure.

In actual implementation, the player character may be directly transformed into the first virtual pet, or the player character and the target virtual pet may be fused to form the first virtual pet.

In some embodiments, if the player character is directly transformed into the first virtual pet, in response to the transformation command for the player character, the process of controlling the form of the player character to be transformed into the first virtual pet may be: in response to the transformation command for the player character, a transformation animation is played. Herein the transformation animation is used to indicate that the player character is being transformed into the first virtual pet; after the transformation animation is played, the first virtual pet obtained from the transformation of the player character is displayed.

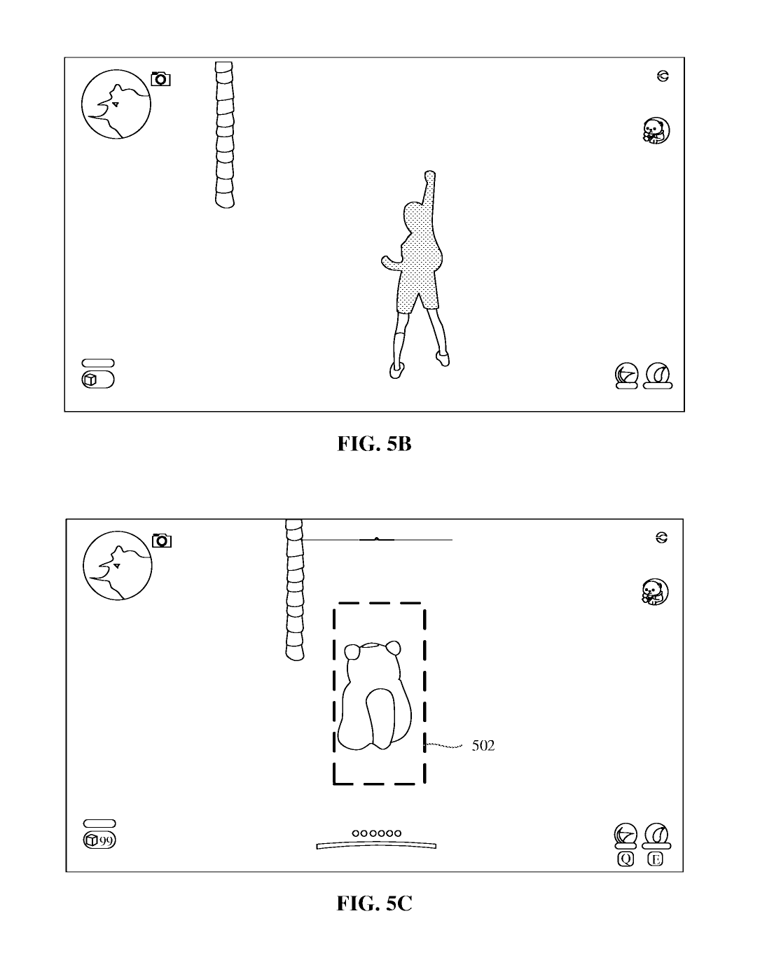

For example, referring to FIG. 5A-FIG. 5C, FIG. 5A-FIG. 5C are schematic diagrams of a process of transforming a form of the player character into the first virtual pet provided by the embodiment of the present disclosure. Based on FIG. 5A-FIG. 5C, the dashed box 501 in FIG. 5A indicates the player character, a transformation animation is played in response to a transformation command for the player character, as illustrated in FIG. 5B. After the transformation animation is played, the first virtual pet obtained from the transformation of the player character is displayed, as illustrated in FIG. 5C, where the dashed box 502 in FIG. 5C is the first virtual pet obtained from the transformation of the player character.

In other embodiments, if the player character and the target virtual pet are fused to form the first virtual pet, the process may be that: it is determined that the transformation command for the player character is triggered in response to the fusion trigger operation for the player character and the at least one target virtual pet, or in response to the player character and the at least one target virtual pet satisfying the automatic fusion condition. Subsequently, in response to the transformation command for the player character, the process of controlling the form of the player character to be transformed into the first virtual pet may be that: in response to the transformation command for the player character, the player character and at least one target virtual pet are fused into the first virtual pet.

It should be noted that the target virtual pet may be any virtual pet, for example, a virtual pet possessed by a player, or a virtual pet possessed by a non-player in a virtual scene, which is not limited by the embodiment of the present disclosure. Meanwhile, the form and/or attribute value of the first virtual pet may be the same as or different from the form and/or attribute value of the target virtual pet. The attribute value includes at least health points, damage points, defense points, speed, and the like.

Herein, the fusion trigger operation may be performed based on the function control, or based on at least one of the keyboard, the mouse or the joystick. The automatic fusion condition includes one of the following: the current environment of the player character includes a virtual pet of the same kind or breed as the target virtual pet; the task object with which the player character is about to interact is of the same kind or breed as the first virtual pet to be synthesized; the interaction task to be performed by the player character is associated with the first virtual pet to be synthesized.

In actual implementation, for the process of fusing the player character and at least one target virtual pet into the first virtual pet, if there is currently only one target virtual pet in the virtual scene, the player character and the only one target virtual pet currently in the virtual scene are fused into the first virtual pet.

Alternatively, if there are currently multiple target virtual pets in the virtual scene, in response to a selection operation for the multiple target virtual pets, the player character is fused with the selected at least one target virtual pet into a second virtual pet.

Alternatively, if the number of target virtual pets is multiple, the player character and at least one target virtual pet selected from the multiple target virtual pets are fused into a first virtual pet in response to an automatic fusion trigger operation, such as a trigger operation for an automatic fusion control, and a trigger operation in the form of voice, somatosensory, or the like. Herein, the selected one target virtual pet is selected and obtained based on a descending order of selection parameters, and the selection parameters are determined by directly selecting one or performing a weighted summation of feature parameters based on at least one of following feature parameters: historical summoning frequency, historical fusion frequency, or attribute values of the target virtual pet. The historical summoning frequency refers to the number or frequency that the player character summons the pet into the virtual scene. As mentioned above, the attribute value at least include health points, damage points, defense points, speed, etc.

In practical application, if there are multiple target virtual pets, the fusion priority of different target virtual pets is usually different. Corresponding display styles may be adopted to display each target virtual pet based on the fusion priority of the target virtual pets. That is, for the target virtual pets with different fusion priorities, different display styles (such as different display orders, different display colors, different display brightness, different display fonts, etc.) are adopted to display each target virtual pet or highlight the target virtual pets with higher fusion priority, to facilitate players to select the required target virtual pets for fusion, thereby improving the pertinence and efficiency of fusion.

For example, if there are multiple target virtual pets, the multiple target virtual pets are displayed in the pet list in a target order. Herein, the target order is sorted based on feature parameters related to the target virtual pets. The feature parameters may include a historical summoning frequency of a target virtual pet (that is, if the target virtual pet is possessed by the player, this refers to the frequency or number of times that the player character summons the target virtual pet into a virtual scene). Generally, the higher the historical summoning frequency of the target virtual pet, the higher the fusion priority of the target virtual pet; and correspondingly, the earlier the display order of the target virtual pet in the pet list. Feature parameters may also include the historical fusion frequency of the target virtual pet (i.e., the frequency or number of times that the player character fuses with the target virtual pet within a historical target time period). Generally, the higher the historical fusion frequency of the target virtual pet, the higher the fusion priority of the target virtual pet; and correspondingly, the earlier the display order of the target virtual pet in the pet list. The feature parameters may further include an attribute value (attack power, defense power, speed, stamina, magic points, etc.) of the skill of the target virtual pet. Generally, the higher the attribute value of the skill of the target virtual pet, the higher the fusion priority of the target virtual pet, and correspondingly, the earlier the display order of the target virtual pet in the pet list.

The feature parameters may further include a degree of match between the skills or powers of the target virtual pet and the current environment of the player character. In general, the greater the degree of the match, the higher the fusion priority of the corresponding target virtual pet, and the earlier the display order of the target virtual pet in the pet list. Herein, the degree of the match may be predicted by calling a machine learning model based on the ability characteristics (i.e., ability types, such as climbing ability, swimming ability, flying ability, ability to expand field of view, night vision ability, detection ability, etc.) of the target virtual pet and the scene feature (i.e., scene types, such as climbing scenes of slopes, swimming scenes of wading, non-contact flying scenes, dark scenes, etc.) of the current scene where the player character is located. The machine learning model is trained in the following manner: based on the ability characteristics of a sample virtual pet and the scene features of the current scene where a sample player character is located, the machine learning model is called to calculate a prediction match degree. Back-propagation is performed based on the difference between the prediction match degree and the actual match result label (1 for match and 0 for no match), to update the parameters of the machine learning model. For example, after determining the value of the loss function of the machine learning model based on the difference between the prediction match degree and the actual match result label (1 for match and 0 for no match), it may be determined whether the value of the loss function exceeds a preset threshold. When the value of the loss function exceeds the preset threshold, an error signal of the machine learning model is determined based on the loss function, the error signal is back-propagated in the machine learning model, and model parameters of each layer are updated during the propagation.

Here, the embodiments of the present disclosure do not limit the model structure of the machine learning model. For example, the machine learning model may be a convolutional neural network, a deep neural network, or the like. The form of loss function is not limited, which may be, for example, a cross-entropy loss function, an L2 loss function, or the like. Here, back-propagation is explained as follows: training sample data is input into the input layer of a neural network model, passes through a hidden layer, and finally reaches the output layer to generate an output result. This is the forward propagation process of the neural network model. Since there is an error between the output result of the neural network model and the actual result, the error between the output result and the actual value is calculated, and this error is back-propagated from the output layer to the hidden layer until this error reaches the input layer. During the back-propagation process, the values of the model parameters are adjusted based on the error, that is, a loss function is constructed based on the error between the output result and the actual value, and the partial derivatives of the loss function with respect to the model parameters are calculated layer by layer to generate gradients of the loss function with respect to the model parameters of each layer. Since the direction of the gradient indicates the direction in which the error increases, the negative of the gradient of the model parameters is taken and then added to the original parameters of each layer model, and the resulting sum is used as the updated model parameters of each layer, thereby reducing the error caused by the model parameters. This process is iterated continuously until convergence. .

It should be noted that when the target virtual pet and the player character are fused, a fusion animation may be played, that is, a process in which the player character and the target virtual pet come into contact, gradually fuse with each other, and transform into the first virtual pet may be displayed. Thus, after the fusion animation is played, the first virtual pet obtained by fusing is displayed.

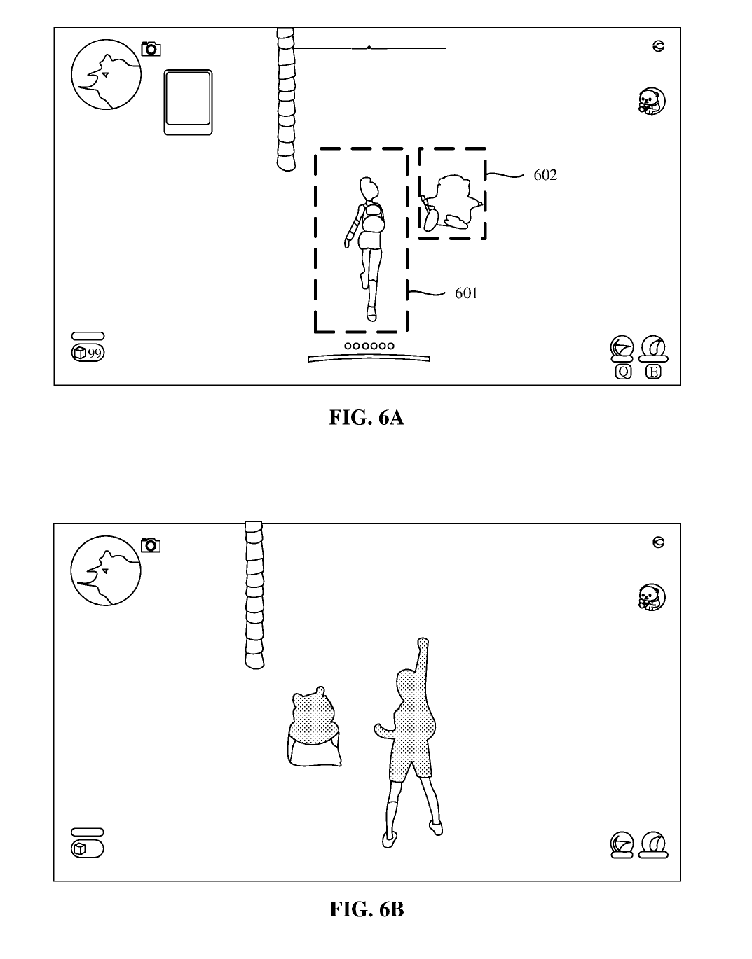

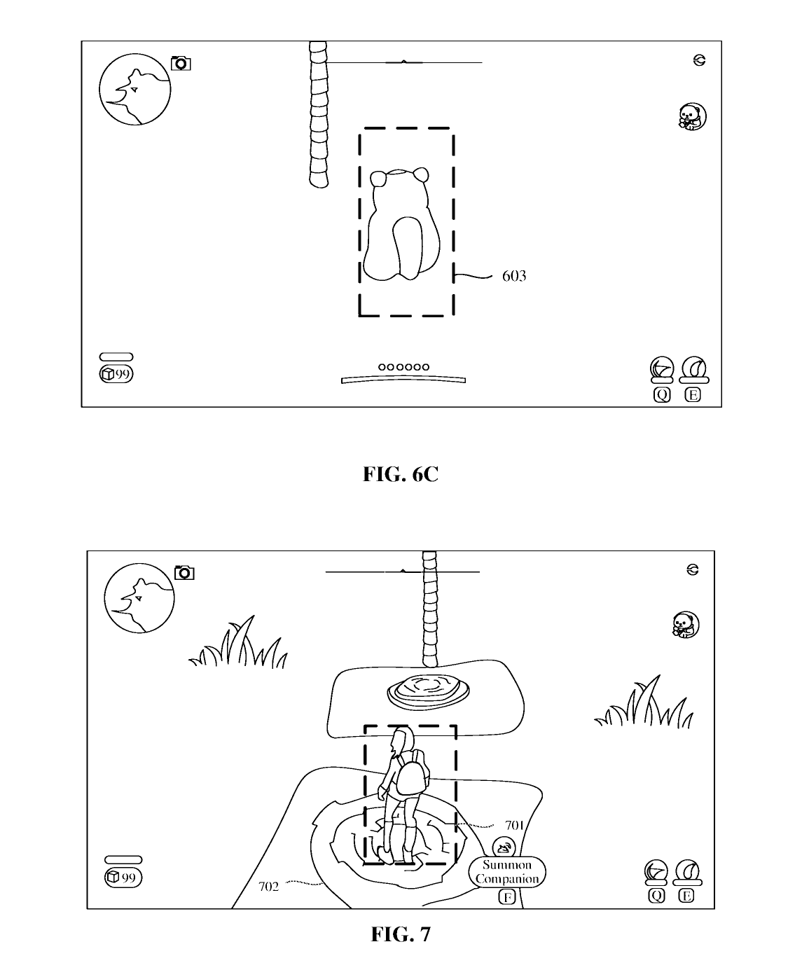

For example, referring to FIG. 6A-FIG. 6C, FIG. 6A-FIG. 6C are schematic diagrams of a process of fusing and forming the first virtual pet through the player character provided by the embodiment of the present disclosure. Based on FIG. 6A-FIG. 6C, a dashed box 601 in FIG. 6A indicates a player character, and a dashed box 602 indicates a target virtual pet. A fusion animation is played in response to a transformation command for the player character, as illustrated in FIG. 6B. After the fusion animation is played, the first virtual pet obtained by fusing the player character and the target virtual pet is displayed, as illustrated in FIG. 6C. Herein, the dashed box 603 in FIG. 6C is the first virtual pet obtained by fusing the player character and the target virtual pet.

In actual implementation, the transformation command for the player character may be triggered based on a transformation operation, a prop, or a virtual scene element or target position.

As an example, when the transformation command for the player character is triggered by a transformation operation, a process of receiving a transformation command for a player character specifically includes that: a transformation control is displayed; in response to a transformation operation triggered based on the transformation control a transformation command for the player character is received; or, in response to a transformation operation triggered based on at least one of a keyboard, a mouse and a joystick, a transformation command for the player character is received.

As an example, when the transformation command for the player character is triggered based on the virtual scene element or the target position, a process of receiving a transformation command for a player character specifically includes that: in response to a movement operation for the player character, the player character is controlled to move toward the virtual scene element or the target position; when the player character moves to the sensing area of the virtual scene element or the target position, a spatial teleportation command is triggered, that is, when the player character is in the sensing area of the virtual scene element or the target position, a stay duration of the player character in the sensing area is displayed; when the stay duration reaches a duration threshold, a transformation command for the player character is triggered.

Herein, the virtual natural phenomenon to which the virtual natural element belongs may be a natural phenomenon caused by such as tornadoes and volcanoes in the environment. The target position is a preset position in the virtual scene, which may be identified by special effects or patterns.

In actual implementation, when the player character is in the sensing area of the virtual scene element or the target position, the sensing area here is a circular area centered on the virtual scene element or the target position with a target distance as the radius. The process of determining that the player character is in the sensing area of the virtual scene element or the target position includes that: the terminal detects the position of the player character in the virtual scene in real time; acquires the position of the virtual scene element or the target position and the sensing area of the virtual scene element or the target position; acquires a distance between the player character and the virtual scene element or the target position based on the position of the player character and the position of the virtual scene element or the target position; and compares the distance with the radius (i.e., the target distance) of the sensing area; when the comparison result indicates that the distance is less than or equal to the radius of the sensing area, it is determined that the player character is in the sensing area of the virtual scene element or the target position.

It should be noted that when the player character is in the sensing area of the virtual scene element or the target position, the transformation command for the player character may be directly triggered. Alternatively, the transformation command for the player character may be triggered based on the duration of the player character in the sensing area. Specifically, when the player character is in the sensing area of the virtual scene element or the target position, the stay duration of the player character in the sensing area may be displayed; when the stay duration reaches the duration threshold, a transformation command for the player character is triggered. Exemplarily, when the player character is in the sensing area of the virtual scene element or the target position, a stay duration of the player character is detected; when the detection result indicates that the stay duration of the player character reaches the duration threshold, such as 5 seconds, a transformation command for the player character is triggered.

For example, referring to FIG. 7, FIG. 7 is a schematic diagram of a player character located at a target position provided by an embodiment of the present disclosure. Based on FIG. 7, a dashed box 701 indicates the player character, and a dashed box 702 indicates the target position. When the player character is in the sensing area of the target position indicated by 702, a transformation command for the player character indicated by the dashed box 701 is triggered.

In some embodiments, the number of first virtual pets to be transformed may be at least one, and the kinds of different first virtual pets are different. If the number of the first virtual pets to be transformed is one, the form of the player character is directly controlled to be transformed into the first virtual pet in response to the transformation command for the player character. That is, the player character is transformed into the first virtual pet. The process of controlling the form of the player character to be transformed into the first virtual pet may be as described earlier that the form of the player character is directly transformed into the first virtual pet, or the player character may be fused with the displayed target virtual pet to transform into the first virtual pet, which is not limited in the embodiment of the present disclosure.

If the number of first virtual pets to be transformed is multiple, the kinds of different first virtual pets are different. In response to the transformation command for the player character, the process of controlling the form of the player character to be transformed into the first virtual pet may be that: in response to the transformation command for the player character, multiple pet options are displayed, and different pet options correspond to different kinds of first virtual pets; in response to a selection operation for a target pet option of the multiple pet options, the player character is transformed into the first virtual pet belonging to a target kind corresponding to the target pet option.

It should be noted that, after triggering the transformation command, the number of first virtual pets to be transformed by the player is obtained. When the number of first virtual pets is multiple, the kinds of multiple first virtual pets are analyzed to obtain the kind of each first virtual pet. Then, multiple pet options are displayed based on the kinds of all first virtual pets. In response to a selection operation for the target pet option of the multiple pet options, the player character is transformed into the first virtual pet belonging to a target kind corresponding to the target pet option. The selection operation for the target pet option of the multiple pet options may be a click operation for the target pet option, including a single-click operation and a double-click operation. Different kinds of first virtual pets have different attribute values, and the attribute values include at least health points, damage points, defense points, speed and the like. In this way, the user can select the virtual pet to be transformed based on different pet options, so as to acquire the attribute value of the corresponding virtual pet, which not only enriches the pet transformation process, but also improves the diversity of interaction modes in the virtual scene and the efficiency of human-computer interaction.

In some embodiments, the virtual scene includes multiple factions, that is, teams. Player characters and/or virtual pets in different factions are in an adversarial relationship. The faction to which the player character belongs also includes at least one other virtual pet. Here, the other virtual pet may be: a virtual pet possessed by the player character themselves, a virtual pet possessed by another character belonging to the same faction as the player character, a virtual pet directly controlled by another user, or an NPC in a virtual scene, or the like. The embodiment of the present disclosure is not limited thereto.

After the form of the player character is controlled to be transformed into the first virtual pet in response to the transformation command for the player character, the following process may be performed: in response to a switching command for the target other virtual pet of the at least one other virtual pet, switching the control from the first virtual pet to target other virtual pet may be performed. Herein, the target other virtual pet is different from the first virtual pet in at least one of form or attribute values. Therefore, in the subsequent process, the process of controlling the first virtual pet to interact with the second virtual pet in response to the interaction command for the first virtual pet may be that: the target other virtual pet is controlled to interact with the second virtual pet in response to the interaction command for the target other virtual pet.

It should be noted that switching the control from the first virtual pet to the target other virtual pet means that: before triggering the switching command for the target other virtual pet of the at least one other virtual pet, the current user may control the player character to move in the virtual scene; after triggering the switching command for the target other virtual pet of the at least one other virtual pet, the current user cannot control the player character to move in the virtual scene, but can control the target other virtual pet to move in the virtual scene; when the user controls the first virtual pet, the other virtual pets may or may not be displayed in the virtual scene; and similarly, when the user controls the target other virtual pet, the first virtual pet may also be displayed in the virtual scene or may not be displayed in the center of the virtual scene.

At the same time, as mentioned above, the attribute values include at least health points, damage points, defense points, speed, etc. The switching command for the target other virtual pet of the at least one other virtual pet may be triggered based on the function control, or may be triggered by at least one of the keyboard, the mouse or the joystick, which is not limited by the embodiment of the present disclosure.

As an example, if the switching command for the target other virtual pet of the at least one other virtual pet is triggered based on the function control, the identifiers of each other virtual pet are displayed in the view interface. Then, in response to a selection operation for the identifier of the target other virtual pet among the respective identifiers, the switching command for the target other virtual pet of the at least one other virtual pet is received.

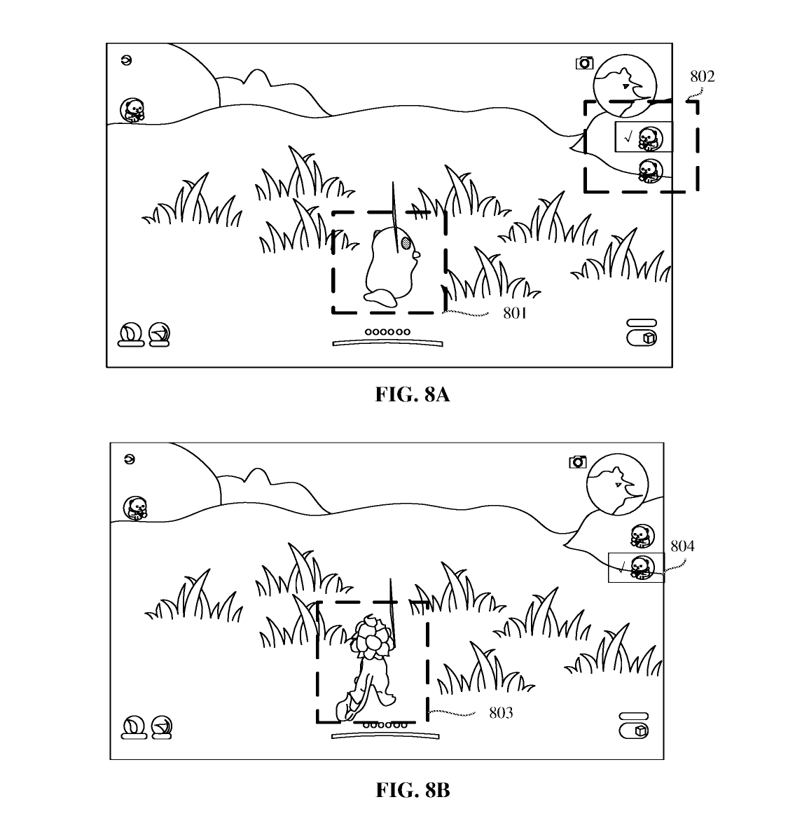

As an example, referring to FIG. 8A-FIG. 8B, FIG. 8A-FIG. 8B are schematic diagrams of a process of switching the control from the first virtual pet to the target other virtual pet provided by the embodiment of the present disclosure. Based on FIG. 8A-FIG. 8B, the faction to which the player character belongs further includes one other virtual pet. The dashed box 801 in FIG. 8A indicates the first virtual pet, and the dashed box 802 indicates the identifiers of the first virtual pet and one other virtual pet included in the faction to which the player character belongs. Herein, the first identifier in dashed box 802 is the identifier of the first virtual pet, and the second identifier is the identifier for the other virtual pet. At this time, the identifier of the first virtual pet is selected, so the first virtual pet is controlled by the player character. When the switching command triggered based on the selection operation of the identifier of the other virtual pet is received, switching the control from the first virtual pet to the target other virtual pet may be performed in response to the switching command of the target other virtual pet, displaying the interface as illustrated in FIG. 8B. Herein the dashed box 803 in FIG. 8B indicates the other virtual pet, and 804 indicates the identifier of the other virtual pet in the selected state.

In some embodiments, the player character is located in a first virtual space in a virtual scene. Before controlling the form of the player character to be transformed into the first virtual pet in response to the transformation command for the player character, the player character may be teleported from the first virtual space to the second virtual space in the virtual scene in response to the spatial teleportation command for the player character. When the player character is located in the second virtual space, the transformation command for the player character is triggered.

It should be noted that, as described above, for triggering the transformation command for the player character, the spatial teleportation command herein may be triggered based on a teleportation operation, a prop, or a virtual scene element.

As an example, when the spatial teleportation command is triggered by a teleportation operation, a process of receiving the spatial teleportation command specifically includes that: a teleportation control is displayed; in response to the teleportation operation triggered based on the teleportation control, the spatial teleportation command is received; or in response to the teleportation operation triggered based on at least one of a keyboard, a mouse or a joystick, a transformation command for the player character is received.

As an example, when the spatial teleportation command is triggered based on the virtual scene element, a process of receiving the spatial teleportation command specifically includes that: a virtual scene element belonging to a natural phenomenon is displayed in the first virtual space; when the player character is in the sensing area of the virtual scene element, a spatial teleportation command is triggered, that is, when the player character is in the sensing area of the virtual scene element, a stay duration of the player character in the sensing area is displayed; when the stay duration reaches the duration threshold, the spatial teleportation command is triggered.

The first virtual space and the second virtual space are both preset and belong to the same virtual scene. The first virtual space and the second virtual space may be set as virtual spaces such as a desert, an ocean, a castle, or a jungle. The first virtual space may be a virtual space including multiple player characters or multiple kinds of virtual pets. The second virtual space may be a virtual space including only the same kind of virtual pets, such as only the first virtual pet and the second virtual pet. That is, the second virtual space may be a breed hub of the first virtual pet and the second virtual pet. The virtual natural phenomenon to which the virtual natural element belongs may be natural phenomenon caused by such as tornadoes and volcanoes in the environment.

In actual implementation, when the player character is in the sensing area of the virtual scene element, the sensing area here is a circular area centered on the virtual scene element with a target distance as the radius. The process of determining that the player character is in the sensing area of the virtual scene element includes that: the terminal detects the position of the player character in the first virtual space in real time, acquires the position of the virtual scene element and the sensing area of the virtual scene element; acquires a distance between the player character and the virtual scene element based on the position of the player character and the position of the virtual scene element; and compares the distance with the radius (i.e., the target distance) of the sensing area; when the comparison result indicates that the distance is less than or equal to the radius of the sensing area, it is determined that the player character is in the sensing area of the virtual scene element.

It should be noted that when the player character is in the sensing area of the virtual scene element, the spatial teleportation command may be directly triggered. Alternatively, the spatial teleportation command may be triggered based on the duration of the player character in the sensing area. Specifically, when the player character is in the sensing area of the virtual scene element, the stay duration of the player character in the sensing area is displayed; when the stay duration reaches the stay duration threshold, the spatial teleportation command is triggered. Exemplarily, when the player character is in the sensing area of the virtual scene element, a stay duration of the player character in the first virtual space is detected; when the detection result indicates that the stay duration of the player character in the first virtual space reaches the stay duration threshold (such as 5 seconds), the spatial teleportation command is triggered.

In operation 103, at least one second virtual pet is displayed, and the second virtual pet is of the same kind as the first virtual pet.

It should be noted that the at least one second virtual pet displayed may be displayed around the first virtual pet when the player character is transformed into the first virtual pet Alternatively, when the first virtual pet is controlled to move in the virtual scene in response to the movement operation for the first virtual pet, the at least one second virtual pet may be displayed during the movement of the first virtual pet. Here, the second virtual pet and the first virtual pet having the same kind means that the first virtual pet and the second virtual pet belong to the same breed, that is, the first virtual pet and the second virtual pet have the same form, or the form similarity reaches a target similarity, such as 95%.

In some embodiments, after the player character is transformed into the first virtual pet, the user may cause the second virtual pet of the same breed as the first virtual pet to assist them in activities in the virtual scene. Specifically, after the at least one second virtual pet is displayed, an interaction command for the first virtual pet may be triggered in response to a summoning operation for the first virtual pet. The summoning operation is used for summoning at least one second virtual pet to cause the at least one second virtual pet to follow the first virtual pet. The summoning operation is triggered by at least one of a summoning control, a joystick, a mouse, or a keyboard.

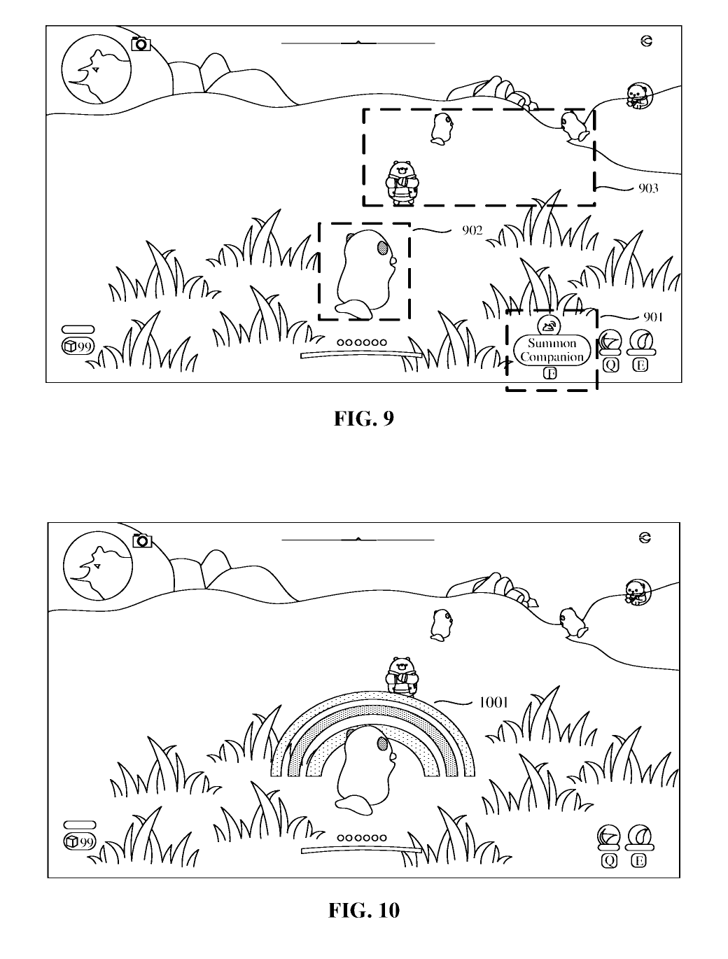

It should be noted that summoning at least one second virtual pet refers to summoning at least one second virtual pet to gather and follow. The summoning operation triggered based on the summoning control is a trigger operation for the summoning control. The summoning operation triggered based on the summoning control may be a click operation (including a single-click operation and a double-click operation) or a press operation (such as a long-press operation) for the summoning control. As an example, referring to FIG. 9, FIG. 9 is a schematic diagram of a summoning control provided by an embodiment of the present disclosure. Based on FIG. 9, a dashed box 901 indicates the summoning control, a dashed box 902 indicates the first virtual pet, and a dashed box 903 indicates the at least one second virtual pet. In response to the trigger operation for the summoning control indicated by the dashed box 901, an interaction command for the first virtual pet indicated by the dashed box 902 is triggered, and the at least one second virtual pet indicated by the dashed box 903 is summoned to follow the first virtual pet.

In other embodiments, after the player character is transformed into the first virtual pet, the user may control the first virtual pet to receive an interaction task from the second virtual pet. Specifically, after displaying at least one second virtual pet, that is, before controlling the first virtual pet to interact with the second virtual pet in response to an interaction command for the first virtual pet, the following process may be performed: the first virtual pet may be controlled to move toward a target second virtual pet of the at least one second virtual pet in response to a movement operation for the first virtual pet, the target second virtual pet being a second virtual pet capable of distributing the interaction task; when the first virtual pet moves to an interactable range of the target second virtual pet, task acquisition guidance information is displayed; in response to a task acquisition operation for the first virtual pet, an interaction command for the first virtual pet is triggered based on the task acquisition guidance information.

It should be noted that when the task acquisition operation is triggered based on the function control, the task acquisition guidance information may include the task acquisition control and guidance information for guiding execution of the task acquisition operation. That is, a trigger operation for the task acquisition control, such as a click operation, to cause the first virtual pet to acquire the interaction task from the target second virtual pet. Alternatively, when the task guidance information is triggered based on at least one of the keyboard, the mouse or the joystick, the task acquisition guidance information may include guidance information for guiding execution of the task acquisition operation. That is, a trigger operation for at least one of the keyboard, the mouse or the joystick, to cause the first virtual pet to acquire the interaction task from the target second virtual pet. In this regard, the embodiments of the present disclosure are not limited.

It should be noted that the interaction task may be a task exclusive to the virtual pet of this breed (this kind), such that only the virtual pet(s) of this kind may perform it. A task identifier may be displayed at associated positions of the target second virtual pet, such as an overhead position, a left position, a right position or a foot position of the target second virtual pet. The task identifier is used to indicate that the corresponding second virtual pet may distribute an interaction task. Here, the style of the task identifier may be preset, which is not limited in the embodiment of the present disclosure. The interactable range is a fixed area (such as a circular area) centered on the target second virtual pet with a target distance as the radius. The terminal detects the positions of the first virtual pet and the target second virtual pet in the virtual scene in real time; acquires the sensing area of the target second virtual pet; acquires the real-time distance between the first virtual pet and the target second virtual pet based on the positions of the first virtual pet and the target second virtual pet; and compares the real-time distance with the radius (that is, the target distance) of the interactable range; when the comparison result indicates that the real-time distance is less than or equal to the radius of the interactable range, it is determined that the first virtual pet moves to the interactable range of the target second virtual pet, and then the task acquisition guidance information is displayed. Here, the task acquisition guidance information may be displayed in the view interface.

In operation 104: in response to the interaction command for the first virtual pet, the first virtual pet is controlled to interact with the second virtual pet.

It should be noted that in response to the interaction command for the first virtual pet, there are many ways of controlling the first virtual pet to interact with the second virtual pet. For example, after summoning the second virtual pet, the first virtual pet and the second virtual pet may perform the interaction task together, or the first virtual pet may directly acquire the interaction task from the second virtual pet without summoning the second virtual pet. Next, taking several of these interaction modes as examples, the process of controlling the first virtual pet to interact with the second virtual pet in response to an interaction command for the first virtual pet is described.

In some embodiments, for the case where the first virtual pet and the second virtual pet may perform an interaction task together after summoning the second virtual pet, after triggering an interaction command for the first virtual pet based on a triggering operation for the summoning control, the process of controlling the first virtual pet to interact with the second virtual pet in response to the interaction command for the first virtual pet may be that: the first virtual pet is controlled to summon the second virtual pet in response to the interaction command for the first virtual pet. During the first virtual pet summoning the second virtual pet, the process of the second virtual pet moving towards the first virtual pet is displayed.

It should be noted that during the first virtual pet summoning the second virtual pet, the process of the second virtual pet moving towards the first virtual pet is displayed, and when the second virtual pet moves to within the target distance of the first virtual pet, the corresponding second virtual pet may stop moving. Meanwhile, when the first virtual pet ends or stops the summoning process, the second virtual pet that has not moved to within the target distance of the first virtual pet stops moving toward the first virtual pet.

In actual implementation, as described above, taking the summoning operation triggered based on the summoning control as an example, the summoning operation may be a click operation (including a single-click operation and a double-click operation) or a press operation (such as a long-press operation) for the summoning control. When the summoning operation is a click operation for the summoning control, after receiving the click operation for the summoning control, a summoning duration and/or a summoning quantity are acquired and displayed. The summoning duration is used to indicate a duration for the first virtual pet to summon second virtual pets, and the summoning quantity indicates the number of second virtual pets summoned. When the second virtual pets are within a target distance of the first virtual pet, it is determined that the second virtual pets are summoned, that is, the summoning quantity may indicate the number of second virtual pets whose distance from the first virtual pet is less than or equal to the target distance. Then, the summoning duration and/or the summoning quantity are detected; and when the detection result indicates that the summoning duration reaches the target summoning duration and/or the summoning quantity reaches the target summoning quantity, the summoning process is stopped. When the summoning operation is a pressing operation for the summoning control, after receiving the pressing operation for the summoning control, the process of continuous pressing the summoning control is the process of summoning the second virtual pet; and the summoning process is stopped when the release operation for the summoning control is received.

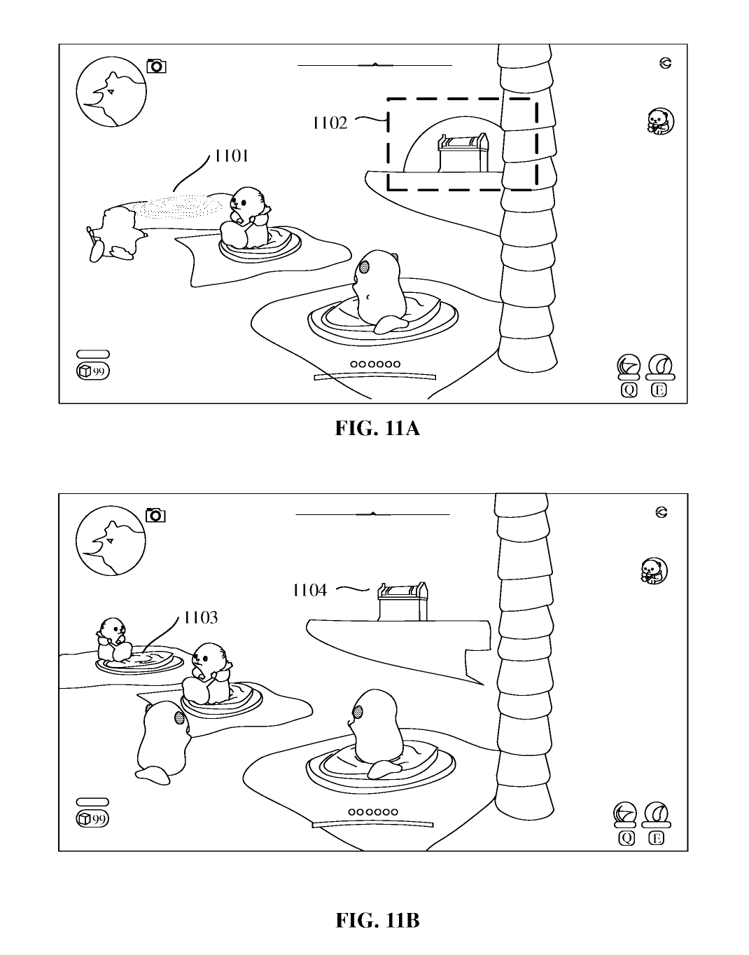

In the process of the first virtual pet summoning the second virtual pets, a summoning special effect or a summoning signal is displayed. The summoning special effect may be preset, thereby prompting that the first virtual pet is summoning based on the summoning special effect. For example, referring to FIG. 10, FIG. 10 is a schematic diagram of a summoning special effect provided by an embodiment of the present disclosure. Based on the summoning special effect indicated by FIG. 10, 1001 indicates the summoning special effect. When the summoning special effect is displayed, it is indicated that the first virtual pet is summoning at least one second virtual pet.

In actual implementation, after displaying a process of the second virtual pet moving toward the first virtual pet, the following process may be performed: the virtual resource in a sealed state is displayed in the virtual scene; in response to the movement operation for the first virtual pet, the first virtual pet is controlled to move toward the virtual resource, and a process of the at least one second virtual pet following the movement of the first virtual pet is displayed; when the first virtual pet and the at least one second virtual pet move to associated positions of the virtual resource, a process of unsealing the virtual resource is displayed; in response to the unsealing of the virtual resource, the virtual resource in the unsealed state is displayed; in response to the pick-up operation for the virtual resource in the unsealed state, the first virtual pet is controlled to pick up the virtual resource.

It should be noted that the virtual resource may be applied to a virtual scene, such as props, an experience points that may increase attribute values or levels, vouchers, or the like. The virtual resource in the sealed state may be, for example, in an inactive states (such as a dimmed state) or wrapped in an isolation shield, or the like. Correspondingly, the unsealed state is an active state, such as a highlighted state, or the disappearance of the isolation shield, or the like. At the same time, the associated positions may be positions around the virtual resource, such as a preset position around the virtual scene. During movement of the first virtual pet and the second virtual pet, a real-time position detection is performed on the first virtual pet and the second virtual pet; and when the detection result indicates that the first virtual pet and at least one second virtual pet are moved to a preset position around the virtual resource, it is determined that the first virtual pet and at least one second virtual pet are moved to the associated positions of the virtual resource.

Herein, there is a sensing area at the associated position. When the first virtual pet and the at least one second virtual pet move to the sensing area of the associated position, it is determined that the first virtual pet and the at least one second virtual pet move to the associated positions around the virtual resource. Here, the sensing area is a fixed area (such as a circular area) centered on the virtual resource with the target distance as the radius. Thus, the terminal detects the positions of the first virtual pet and the at least one second virtual pet in the virtual scene in real time; acquires the associated positions of the virtual resource and the sensing area of the associated position; based on the positions of the first virtual pet and the at least one second virtual pet and the associated position, acquires the distance between the first virtual pet and the at least one second virtual pet and the associated position; and compares the distance with the radius (i.e., target distance) of the sensing area; when the comparison result indicates that the distance is less than or equal to the radius of the sensing area, it is determined that that the first virtual pet and the at least one second virtual pet move to the associated positions around the virtual resource.

In some embodiments, the number of associated positions is multiple, each associated position corresponds to a pattern. Before displaying the process of unsealing the virtual resource, the following process may be performed: in response to a movement operation for the first virtual pet, the first virtual pet is controlled to move to a target pattern of multiple patterns; when the first virtual pet moves to a sensing area of the target pattern, the target pattern is switched from a first style to a second style, a process of at least one second virtual pet moving to the other pattern is displayed; when the second virtual pet moves to the sensing area of the other pattern, the other pattern is switched from the first style to the second style; in response to the patterns of each associated position being switched to the second style, it is determined that the first virtual pet and the at least one second virtual pet move to the associated positions of the virtual resource.

It should be noted that the patterns corresponding to the associated positions may be the same or different. The patterns corresponding to the associated positions serve as identifiers for the associated positions, which are used to indicate specific positions of the associated positions. The first style and the second style may be preset. For example, the first style may be a dimmed state, and the second style may be a highlighted state; or the first style may be a blue state, and the second style may be a red state; or the first style may be a normal state, and the second style may be a special effect state, etc., which is not limited in the embodiment of the present disclosure. The process of determining that the first virtual pet moves to the sensing area of the target pattern and determining that the second virtual pet moves to the sensing area of the other pattern is similar to the process of determining that the first virtual pet and at least one second virtual pet move to the sensing area of the associated positions of the virtual resource, as described above, and thus will not be elaborated on the embodiment of the present disclosure.

For example, referring to FIG. 11A-FIG. 11B, FIG. 11A-FIG. 11B are schematic diagrams of patterns of associated positions provided by the embodiment of the present disclosure. Based on FIG. 11A-FIG. 11B, the dashed box 1102 indicates a virtual resource in a sealed state, where there are three associated positions corresponding to three identical patterns respectively. Taking the associated position indicated by 1101 in FIG. 11A as an example, since no virtual pet moves to this associated position, the pattern corresponding to the associated position is in the first style, that is, the dimmed state indicated in FIG. 11A. When a virtual pet moves to this position, the pattern corresponding to this associated position is switched from the first style to the second style, i.e., the style indicated by 1103 in FIG. 11B. Thus, as illustrated in FIG. 11B, when the patterns at all associated positions are switched to the second style, it is determined that the first virtual pet and at least one second virtual pet move to the associated position of the virtual resource, the virtual resource in a sealed state is unsealed, and the virtual resource in the unsealed state is displayed as indicated by 1104 in FIG. 11B.

In some embodiments, for the case where the first virtual pet directly acquires the interaction task from the second virtual pet to perform, after the interaction command for the first virtual pet is triggered, the process of controlling the first virtual pet to interact with the second virtual pet in response to the interaction command for the first virtual pet may be that: the first virtual pet is controlled to acquire the interaction task distributed by the target second virtual pet in response to the interaction command for the first virtual pet.

It should be noted that the interaction task distributed by the target second virtual pet may be of various types. For example, the interaction task may be watching promotional videos, collecting target props, or defeating target objects, etc., the embodiment of the present disclosure is not limited thereto.

In actual implementation, after controlling the first virtual pet to acquire the interaction task distributed by the target second virtual pet, the following process may be performed: in response to the task execution command for the first virtual pet, the process of the first virtual pet performing the interaction task is displayed; when the first virtual pet completes the interaction task, the first virtual pet is controlled to acquire a virtual resource from the target second virtual pet in response to the first virtual pet being located in an interactable range of the target second virtual pet, and the virtual resource is used as a reward for completing the interaction task.

It should be noted that the after the first virtual pet completes the interaction task, in response to a movement command for the first virtual pet, the first virtual pet is controlled to move toward the target second virtual pet; and when the first virtual pet moves to the interactable range of the target second virtual pet, it is determined that the first virtual pet is located in the interactable range of the target second virtual pet. Here, the process of determining that the first virtual pet is located in the interactable range of the target second virtual pet is the same as the process of determining that the first virtual pet is located in the interactable range of the target second virtual pet for displaying the task acquisition guidance information as described above. Here, the embodiment of the present disclosure will not be described in detail.

It should be noted that when the first virtual pet is located in the interactable range of the target second virtual pet, the resource acquisition control is displayed; in response to a trigger operation for the resource acquisition control, the first virtual pet is controlled to acquire the virtual resource from the target second virtual pet; or in response to a trigger operation for at least one of a joystick, a mouse, and a keyboard directly, the first virtual pet is controlled to acquire the virtual resource from the target second virtual pet. Here, the virtual resource is similar to those described above and may be applied to the virtual scene. The virtual resource may be, for example, props, an experience points that may increase attribute values or levels, vouchers, or the like. At the same time, the resource acquisition control may be the same control as the task acquisition control described above, and the function of the control depends on whether the first virtual pet acquires the interaction task. Before the first virtual pet acquires the interaction task, the control is a task acquisition control for acquiring the task distributed by the target second virtual pet; and after the first virtual pet acquires and interacts the task, the control is a resource acquisition control for acquiring the virtual resource from the target second virtual pet. Correspondingly, the trigger operation for at least one of the joystick, the mouse or the keyboard performed for acquiring the virtual resource is the same as the trigger operation for at least one of the joystick, the mouse or the keyboard performed for acquiring the interaction task described above. The difference is that: before the first virtual pet acquires the interaction task, the trigger operation for at least one of the joystick, the mouse or the keyboard is used for acquiring the interaction task; while after the first virtual pet acquires and interacts the task, the trigger operation for at least one of the joystick, the mouse or the keyboard is used for acquiring the virtual resource.

As an example, the interaction task is to pick up a target quantity of virtual props. In response to the first virtual pet being located in the interactable range of the target second virtual pet, the process of controlling the first virtual pet to acquire the virtual resource from the target second virtual pet may be as follows: in response to the first virtual pet being located in the interactable range of the target second virtual pet, at least two quantity options are displayed, and different quantity options correspond to different quantities and are less than or equal to the target quantity; in response to a selection operation for a target quantity option of the at least two quantity options, the quantity of virtual props corresponding to the target quantity option are delivered to the target second virtual pet, and the first virtual pet is controlled to acquire corresponding virtual resource from the target second virtual pet.

It should be noted that the interaction task is to pick up a target quantity of virtual props. That is, the interaction task is to pick up a target quantity of virtual props for the target second virtual pet. Different quantity options correspond to different quantities, and each quantity is less than or equal to the target quantity. Each quantity option is used to indicate the delivery of the corresponding quantity of virtual props to the target second virtual pet, and different virtual resources may be acquired by delivering different quantities of virtual props, that is, each quantity option has a corresponding virtual resource.

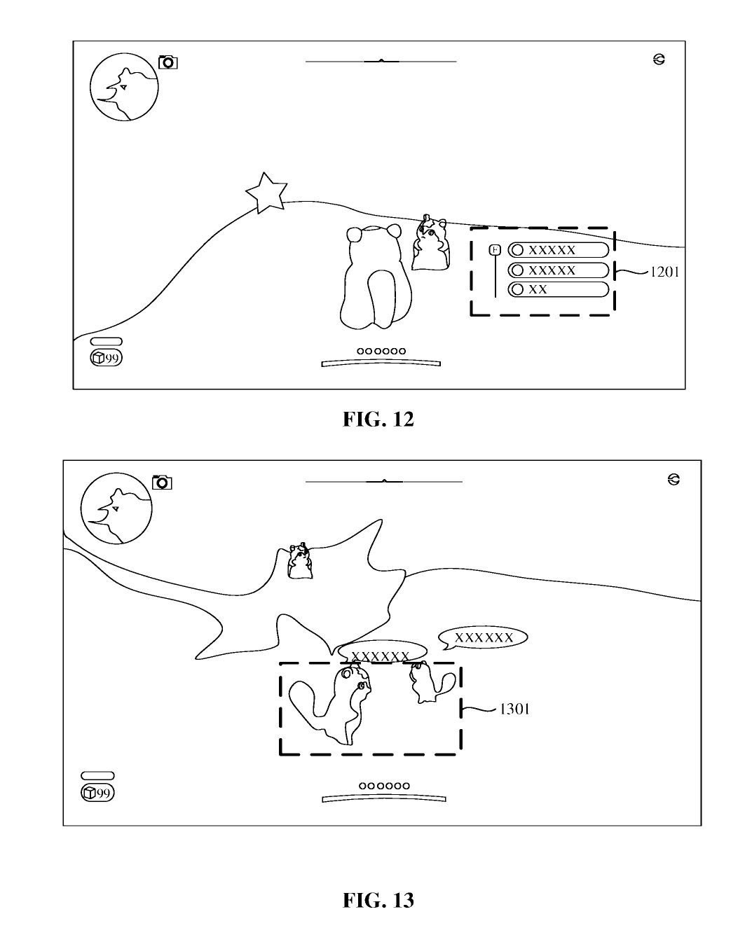

Exemplarily, referring to FIG. 12, FIG. 12 is a schematic diagram of a process of delivering an interaction task provided by an embodiment of the present disclosure. Based on FIG. 12, the dashed box 1201 indicates three quantity options. In response to a selection operation for a target quantity option of the three quantity options, the quantity of virtual props corresponding to the target quantity option is delivered to the target second virtual pet, and the first virtual pet is controlled to acquire corresponding virtual resource from the target second virtual pet.

In another embodiment, for the case where the first virtual pet directly communicates with the second virtual pet, the interaction command is triggered by a pet communication operation performed on the first virtual pet. After the interaction command for the first virtual pet is triggered based on the pet communication operation, and in response to the interaction command for the first virtual pet, a process of controlling the first virtual pet to interact with the second virtual pet may be as follows: in response to the interaction command triggered based on the pet communication operation, the first virtual pet is controlled to communicate with the second virtual pet; a communication reply from the second virtual pet to the first virtual pet is outputted during the communication between the first virtual pet and the second virtual pet. Herein, the communication reply is used to prompt the interaction operation that is able performed by the first virtual pet in the virtual scene.

It should be noted that the pet communication operation may be performed based on a function control, or based on at least one of a joystick, a mouse or a keyboard, and the embodiment of the present disclosure is not limited thereto. The communication content output by the first virtual pet may be preset or input by a user. The input mode may be text input, voice input, or the like, and the embodiment of the present disclosure is not limit thereto. Correspondingly, the output mode of the communication reply from the second virtual pet to the first virtual pet may be voice, text, or the like.

Herein, the first virtual pet may obtain target information (such as a special gameplay) in the virtual scene through communication with the second virtual pet. For example, when the user is a new user and the second virtual pet is an NPC or a virtual pet possessed by another veteran player, after the player character controlled by the user is transformed into the virtual pet, it may communicate with the second virtual pet, to acquire gameplay information in the virtual scene, i.e., guidance information.

For example, referring to FIG. 13, FIG. 13 is a schematic diagram of communication between the first virtual pet and the second virtual pet provided by an embodiment of the present disclosure. Based on FIG. 13, the dashed box 1301 indicates the first virtual pet and the second virtual pet, where the first virtual pet and the second virtual pet are communicating, and text content in the communication between the first virtual pet and the second virtual pet are displayed.

In some embodiments, the virtual scene includes at least two scene areas. The first virtual pet is located in the first scene area of the virtual scene. In response to the interaction command for the first virtual pet, after controlling the first virtual pet to interact with the second virtual pet, the following process may be performed: in response to the movement command for the first virtual pet, the first virtual pet may be controlled to move from the first scene area to the second scene area of the virtual scene, herein, the second scene area includes a third virtual pet, and the third virtual pet is of a different kind from the first virtual pet; when the first virtual pet is located in the second scene area, the form of the first virtual pet is controlled to be transformed into the third virtual pet.

It should be noted that different scene areas indicate different positions in the virtual scene, and at least two scene areas form the virtual scene, that is, the virtual scene is composed of at least two scene areas joined together. Herein, the second scene area may be a gathering place of the third virtual pet, that is, the third virtual pet is a unique pet in the second scene area, and there is no third virtual pet or only a small quantity (less than a quantity threshold) of third virtual pets in other scene area, so that the form of the first virtual pet may be controlled to be transformed into the third virtual pet when the first virtual pet is located in the second scene area. In this way, the user can control the third virtual pet to move in the second scene area and interact or communicate with other third virtual pets in the second scene area.

In some embodiments, in response to the interaction command for the first virtual pet, after controlling the first virtual pet to interact with the second virtual pet, the following process may be performed: in response to the fusion command for the first virtual pet, the first virtual pet may be controlled to fuse with the second virtual pet, and the fourth virtual pet obtained by fusing is displayed. Herein, the attribute values of the fourth virtual pet are higher than the attribute values of the first virtual pet.

It should be noted that, as mentioned above, attribute values at least include health points, damage points, defense points, speed etc. In the process of controlling the first virtual pet to fuse with the second virtual pet, a fusion animation or a fusion special effect may be displayed. The fusion animation or the fusion special effect is used to indicate that the first virtual pet and the second virtual pet are fusing. At the same time, attribute values of the fourth virtual pet obtained from the fusion may be positively correlated with the quantity of the second virtual pets fused. Alternatively, the attribute values of the fourth virtual pets obtained from the fusion are the same regardless of the quantity of the second virtual pets that are fused, which is not limited in the embodiment of the present disclosure.

In some embodiments, after displaying the at least one second virtual pet, an attackable object may also be displayed. In response to the attack command for the first virtual pet, the first virtual pet is controlled to attack the attackable object, and a process of at least one second virtual pet attacking the attackable object is displayed.

It should be noted that the attackable object may be an NPC or a monster, or may be a virtual pet or a virtual character belonging to a different faction from the first virtual pet in the virtual scene, and the virtual pet or virtual character may be controlled by another user. Thus, when the first virtual pet attacks the attackable object, the at least one second virtual pet also follows the first virtual pet to attack the attackable object.

In some embodiments, in response to the transformation command for the player character, after controlling the form of the player character to be transformed into the first virtual pet, the first virtual pet may be further transformed back into the player character. Specifically, in response to the transformation command for the first virtual pet, the form of the first virtual pet is controlled to be transformed into the player character. Herein, the process of receiving the transformation-back command for the first virtual pet is similar to the process of receiving the transformation command for the player character described above, and the process of receiving the transformation-back command for the first virtual pet specifically includes that: the transformation-back control is displayed; in response to the trigger operation for the transformation-back control, a transformation-back command for the first virtual pet is received; or, in response to a transformation-back operation triggered based on at least one of a keyboard, a mouse or a joystick, a transformation-back command for the first virtual pet is received; alternatively, the fusion duration of the player character and the target virtual pet reaches a preset duration, or the second virtual pet completes the interaction task or the like, and this is not limited by the embodiment of the present disclosure.

The preset duration may be preset, for example, 10 minutes. Meanwhile, if the player character is directly transformed into the first virtual pet, the first virtual pet is directly transformed into the player character when the transformation command for the first virtual pet is received. If the player character is transformed into the first virtual pet based on the player character and the first virtual pet fused, the first virtual pet is transformed into the player character when the transformation command for the first virtual pet is received, and the first virtual pet possessed by the player character is displayed.

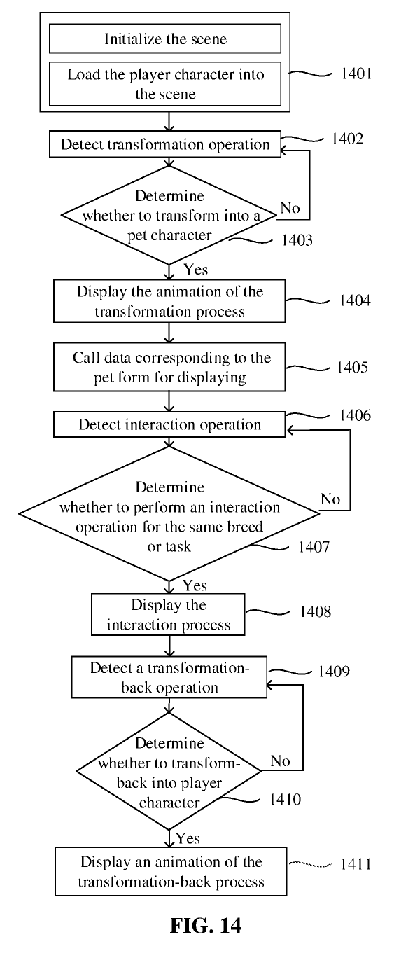

In some embodiments, referring to FIG. 14, FIG. 14 is a flowchart of a method for interaction in virtual scene provided by an embodiment of the present disclosure. Based on FIG. 14, in the operation 1401, the virtual scene is firstly initialized, and a character (that is, a player character) controlled by a user is loaded into the virtual scene. In operation 1402-operation 1403, an operation on the player character is detected in real-time, and whether to perform a transformation operation for the player character is determined based on the detection result, that is, whether to trigger a transformation command for the player character is determined, to determine whether to transform the player character into a pet character. In operation 1404-operation 1405, when it is determined that the player character is transformed into the pet character, an animation of the transformation process is displayed; and after the animation is finished, data corresponding to the pet form is called to display the pet character. In operation 1406-operation 1408, an operation on the pet character is detected in real-time, whether to perform an interaction operation for the same breed or task is determined based on the detection result; and when it is determined that the interaction operation for the same breed or task is performed, an interaction process of the pet character is displayed. In operation 1409-operation 1411: the pet character is detected in real-time, whether to perform a transformation-back operation for the pet character is determined based on the detection result, that is, whether a transformation-back command for the pet character is triggered based on the detection result, to determine whether to transform the pet character into the player character, and an animation of the transformation-back process is displayed when it is determined that the pet character is transformed into the player character; and after the animation is finished, the transformed character is displayed.

By applying the above-described embodiments of the present disclosure, after the player character with the first pet object is displayed in the virtual scene, the form of the player character is controlled to be transformed into the first virtual pet in response to the transformation command for the player character. Then, after at least one second virtual pet of the same kind as the first virtual pet is displayed, the first virtual pet is controlled to interact with the second virtual pet in response to the interaction command for the first virtual pet. In this way, by transforming the player character into a virtual pet, and then making the virtual pet interact with other virtual pets of the same kind, not only enriches the interaction modes for the virtual pet, but also improves the diversity of the interaction modes in the virtual scene, and also improves the human-computer interaction efficiency and the hardware resource utilization rate of the electronic device.

The implementation of the interaction device 455 in virtual scene provided by an embodiment of the disclosure as software modules will be further described below. In some embodiments, as illustrated in FIG. 2, the software module in the interaction device 455 in the virtual scene stored in the memory 450 may include a first displaying module 4551, a first controlling module 4552, a second displaying module 4553, and a second controlling module 4554.

The first displaying module 4551 is configured to display a player character in a virtual scene.

The first controlling module 4552 is configured to control the form of the player character to be transformed into a first virtual pet in response to a transformation command for the player character.

The second displaying module 4553 is configured to display at least one second virtual pet being of the same kind as the first virtual pet.

The second controlling module 4554 is configured to control the first virtual pet to interact with the second virtual pet in response to an interaction command for the first virtual pet.

In some embodiments, the device further includes a third displaying module, the third displaying module is configured to trigger an interaction command for the first virtual pet in response to a summoning operation for the first virtual pet. Herein, the summoning operation is used for summoning the at least one second virtual pet to follow the first virtual pet. The summoning operation is triggered by at least one of a summoning control, a joystick, a mouse, or a keyboard.

In some embodiments, the second controlling module 4554 is further configured to: control the first virtual pet to summon the second virtual pet in response to an interaction command for the first virtual pet; and during the first virtual pet summoning the second virtual pet, display the process of the second virtual pet moving toward the first virtual pet.

In some embodiments, the device further includes a fourth displaying module, the fourth displaying module is configured to: display a virtual resource in a sealed state in the virtual scene; in response to a movement operation for the first virtual pet, control the first virtual pet to move toward the virtual resource and display a process of the at least one second virtual pet following the movement of the first virtual pet; in response to the first virtual pet and the at least one second virtual pet moving to associated positions of the virtual resource, display a process of unsealing the virtual resource; in response to unsealing of the virtual resource, display the virtual resource in an unsealed state; and control the first virtual pet to pick up the virtual resource in response to a pick-up operation for the virtual resource in the unsealed state.

In some embodiments, the number of the associated positions is multiple, each of the associated positions corresponds to a pattern. The device further includes a third controlling module, and the third controlling module is configured to: control the first virtual pet to move toward a target pattern of the multiple patterns in response to a movement operation for the first virtual pet; in response to the first virtual pet moving to the sensing area of the target pattern, switch the target pattern from a first style to a second style; display a process of the at least one second virtual pet moving toward another pattern, and switch the another pattern from the first style to the second style in response to the second virtual pet moving to the sensing area of the another pattern; determine that the first virtual pet and the at least one second virtual pet move to associated positions of the virtual resource in response to the patterns of all associated positions being switched to the second style.

In some embodiments, the device further includes a fourth controlling module. The fourth controlling module is configured to: control the first virtual pet to move toward a target second virtual pet of the at least one second virtual pet in response to a movement operation for the first virtual pet, the target second virtual pet being a second virtual pet capable of distributing an interaction task; display task acquisition guidance information in response to the first virtual pet moving to an interactable range of the target second virtual pet; in response to a task acquisition operation for the first virtual pet, trigger an interaction command for the first virtual pet based on the task acquisition guidance information. The second controlling module 4554 is further configured to: in response to the interaction command for the first virtual pet, control the first virtual pet to acquire the interaction task distributed by the target second virtual pet.

In some embodiments, the device further includes a fifth displaying module. The fifth displaying module is configured to: in response to a task execution command for the first virtual pet, display a process of the first virtual pet performing the interaction task; in response to the first virtual pet completing the interaction task, and in response to the first virtual pet being located in the interactable range of the target second virtual pet, control the first virtual pet to acquire a virtual resource from the target second virtual pet, herein, the virtual resource is used as a reward for completing the interaction task.

In some embodiments, the interaction task is to pick up a target quantity of virtual props. The fifth displaying module is further configured to: in response to the first virtual pet being located in the interactable range of the target second virtual pet, display at least two quantity options, different quantity options correspond to different quantities and are less than or equal to the target quantity; in response to a selection operation for a target quantity option of the at least two quantity options, deliver a quantity of virtual props corresponding to the target quantity option to the target second virtual pet, and control the first virtual pet to acquire a corresponding virtual resource from the target second virtual pet.

In some embodiments, the interaction command is triggered by a pet communication operation performed on the first virtual pet, and the second controlling module 4554 is further configured to: in response to the interaction command triggered based on the pet communication operation, control the first virtual pet to communicate with the second virtual pet; output a communication reply from the second virtual pet to the first virtual pet during communication between the first virtual pet and the second virtual pet. Herein, the communication reply is used to prompt an interaction operation that is able performed by the first virtual pet in the virtual scene.

In some embodiments, the virtual scene includes at least two scene areas. The first virtual pet is located in a first scene area of the virtual scene. The device further includes a fifth controlling module. The fifth controlling module is configured to: in response to a movement command for the first virtual pet, control the first virtual pet to move from the first scene area to a second scene area of the virtual scene, herein, the second scene area includes a third virtual pet, and the third virtual pet is of a different kind from the first virtual pet; in response to the first virtual pet being located in the second scene area, control a form of the first virtual pet to be transformed into the third virtual pet.

In some embodiments, the player character is located in a first virtual space in the virtual scene. The device further includes a teleportation module. The teleportation module is configured to: in response to a spatial teleportation command for the player character, teleport the player character from the first virtual space to a second virtual space of the virtual scene; in response to the player character being located in the second virtual space, trigger a transformation command for the player character.

In some embodiments, the faction to which the player character belongs further includes at least one other virtual pet. The device further includes a switching module. The switching module is configured to: in response to a switching command for a target other virtual pet of the at least one other virtual pet, switch the control from the first virtual pet to the target other virtual pet, herein, the target other virtual pet is different from the first virtual pet in at least one of a form or attribute values. The second controlling module 4554 is further configured to: in response to an interaction command for the target other virtual pet, control the target other virtual pet to interact with the second virtual pet.

In some embodiments, the number of first virtual pets to be transformed may be at least one, and the kinds of different first virtual pets are different. The first controlling module 4552 is further configured to: in response to a transformation command for the player character, display multiple pet options, herein, different pet options correspond to different kinds of the first virtual pets; in response to a selection operation for a target pet option of the multiple pet options, transform the player character into the first virtual pet belonging to a target kind corresponding to the target pet option.

In some embodiments, the device further includes a sixth controlling module, and the sixth controlling module is configured to: in response to a fusion command for the first virtual pet, control the first virtual pet to fuse with the second virtual pet, and display a fourth virtual pet obtained through the fusing. Herein, the attribute values of the fourth virtual pet are higher than the attribute values of the first virtual pet.

In some embodiments, the device further includes a sixth displaying module. The sixth displaying module is configured to: display an attackable object; in response to an attack command for the first virtual pet, control the first virtual pet to attack the attackable object and display a process of the at least one second virtual pet attacking the attackable object.

Embodiments of the present disclosure provide a computer program product including computer-executable instructions or computer programs stored in a computer-readable storage medium. The processor of the electronic device reads the computer-executable instructions or the computer programs from the computer-readable storage medium, and the processor executes the computer-executable instructions or the computer programs, to cause the electronic device to perform the method for the interaction in the virtual scene described above in the embodiments of the present disclosure.

Embodiments of the present disclosure provide a computer-readable storage medium having stored thereon computer-executable instructions or computer programs that, when executed by a processor, cause the processor to execute the method for the interaction in a virtual scene provided by the embodiment of the present disclosure, for example, the method for the interaction in a virtual scene as illustrated in FIG. 3.

In some embodiments, the computer-readable storage medium may be a memory, such as a Read-Only Memory (ROM), a Random Access Memory (RAM), an Erasable Programmable Read-Only Memory (EPROM), an Electrically Erasable Programmable Read-Only Memory (EEPROM), a flash memory, a magnetic surface memory, an optical disk, or a CD-ROM; It may also be a variety of devices including one or any combination of the above-mentioned memories.

In some embodiments, the computer-executable instructions may take the form of programs, software, software modules, scripts, or code, written in any form of programming language (including compiled or interpreted languages, or declarative or procedural languages). a Moreover, the computer-executable instructions may be deployed in any form, including as standalone programs or as modules, components, subroutines, or other units suitable for use in a computing environment.

As an example, computer-executable instructions may, but do not necessarily correspond to files in a file system. The computer-executable instructions may be stored as part of a file that holds other programs or data, for example, stored in one or more scripts in a Hyper Text Markup Language (HTML) document, in a single file dedicated to the program in question, or in multiple collaborative files (e.g., files storing one or more modules, subroutines, or portions of code).

As an example, the computer-executable instructions may be deployed to execute on a single electronic device, or on multiple electronic devices located at a single site, or on multiple electronic devices distributed across multiple sites and interconnected via a communication network.

It should be noted that in the embodiments of the present disclosure, when it involves acquiring operation data and other related data of users, if these embodiments are applied to specific products or technologies, it is necessary to obtain the user's permission or consent. Moreover, the collection, use, and processing of relevant data must comply with the relevant laws, regulations, and standards of the corresponding countries and regions.

The embodiments described above are merely exemplary and are not intended to limit the scope of protection of the present disclosure. Any modifications, equivalent substitutions and improvements, or the like made within the spirit and scope of the present disclosure shall be included within the scope of protection of the present disclosure.

1. A method for interaction in a virtual scene, comprising:
displaying a player character in the virtual scene;
in response to a transformation command for the player character, controlling a form of the player character to be transformed into a first virtual pet;
displaying at least one second virtual pet of a same kind as the first virtual pet; and
in response to an interaction command for the first virtual pet, controlling the first virtual pet to interact with the at least one second virtual pet.

2. The method of claim 1, wherein after displaying the at least one second virtual pet, the method further comprises:
in response to a summoning operation for the first virtual pet, triggering an interaction command for the first virtual pet; and
wherein the summoning operation is used for summoning the at least one second virtual pet to follow the first virtual pet, and the summoning operation is triggered by at least one of a summoning control, a joystick, a mouse, or a keyboard.

3. The method of claim 2, wherein in response to the interaction command for the first virtual pet, controlling the first virtual pet to interact with the at least one second virtual pet, comprises:
in response to the interaction command for the first virtual pet, controlling the first virtual pet to summon the at least one second virtual pet; and
displaying a process of the second virtual pet moving toward the first virtual pet during the first virtual pet summoning the at least one second virtual pet.

4. The method of claim 3, wherein after displaying the process of the at least one second virtual pet moving toward the first virtual pet, the method further comprises:
displaying a virtual resource in a sealed state in the virtual scene;
in response to a movement operation for the first virtual pet, controlling the first virtual pet to move toward the virtual resource, and displaying a process of the at least one second virtual pet following a movement of the first virtual pet;
in response to the first virtual pet and the at least one second virtual pet moving to associated positions of the virtual resource, displaying a process of unsealing the virtual resource;
in response to unsealing of the virtual resource, displaying the virtual resource in an unsealed state; and
in response to a pick-up operation for the virtual resource in the unsealed state, controlling the first virtual pet to pick up the virtual resource.

5. The method of claim 4, wherein a number of the associated positions is multiple, each of the associated position corresponds to a pattern, and before displaying the process of unsealing the virtual resource, the method further comprises:
in response to a movement operation for the first virtual pet, controlling the first virtual pet to move toward a target pattern of a plurality of patterns;
in response to the first virtual pet moving to a sensing area of the target pattern, switching the target pattern from a first style to a second style;
displaying a process of the at least one second virtual pet moving toward another pattern, and switching the another pattern from the first style to the second style in response to the at least one second virtual pet moving to an sensing area of the another pattern; and
in response to the plurality of patterns of the associated positions switching to the second style, determining that the first virtual pet and the at least one second virtual pet move to the associated positions of the virtual resource.

6. The method of claim 1, wherein before the operation of in response to the interaction command for the first virtual pet, controlling the first virtual pet to interact with the at least one second virtual pet, the method further comprises:
in response to a movement operation for the first virtual pet, controlling the first virtual pet to move toward a target second virtual pet of the at least one second virtual pet, wherein the target second virtual pet is a second virtual pet that distributes an interaction task;
in response to the first virtual pet moving to an interactable range of the target second virtual pet, displaying task acquisition guidance information; and
in response to a task acquisition operation for the first virtual pet, triggering an interaction command for the first virtual pet based on the task acquisition guidance information;
wherein in response to the interaction command for the first virtual pet, controlling the first virtual pet to interact with the at least one second virtual pet, comprises:
in response to the interaction command for the first virtual pet, controlling the first virtual pet to acquire the interaction task distributed by the target second virtual pet.

7. The method of claim 6, wherein after controlling the first virtual pet to acquire the interaction task distributed by the target second virtual pet, the method further comprises:
in response to a task execution command for the first virtual pet, displaying a process of the first virtual pet performing the interaction task; and
in response to the first virtual pet completing the interaction task, and in response to the first virtual pet being located in the interactable range of the target second virtual pet, controlling the first virtual pet to acquire a virtual resource from the target second virtual pet, the virtual resource being used as a reward for completing the interaction task.

8. The method of claim 7, wherein the interaction task is to pick up a target quantity of virtual props; and in response to the first virtual pet being located in the interactable range of the target second virtual pet, controlling the first virtual pet to acquire the virtual resource from the target second virtual pet, comprises:
in response to the first virtual pet being located in the interactable range of the target second virtual pet, displaying at least two quantity options; wherein different quantity options correspond to different quantities and are less than or equal to the target quantity; and
in response to a selection operation for a target quantity option of the at least two quantity options, delivering a quantity of virtual props corresponding to the target quantity option to the target second virtual pet, and controlling the first virtual pet to acquire the corresponding virtual resource from the target second virtual pet.

9. The method of claim 1, wherein the interaction command is triggered by a pet communication operation performed on the first virtual pet; and in response to the interaction command for the first virtual pet, controlling the first virtual pet to interact with the at least one second virtual pet, comprises:
in response to the interaction command triggered based on the pet communication operation, controlling the first virtual pet to communicate with the at least one second virtual pet;
outputting a communication reply from the at least one second virtual pet to the first virtual pet during communication between the first virtual pet and the at least one second virtual pet; and
wherein the communication reply is used to prompt an interaction operation that is able performed by the first virtual pet in the virtual scene.

10. A device for interaction in a virtual scene, comprising:
a processor; and
a memory configured to store a computer program executable for the processor,
wherein the processor is configured to:
display a player character in the virtual scene;
in response to a transformation command for the player character, control a form of the player character to be transformed into a first virtual pet;
display at least one second virtual pet of a same kind as the first virtual pet; and
in response to an interaction command for the first virtual pet, control the first virtual pet to interact with the at least one second virtual pet.

11. The device of claim 10, wherein the processor is further configured to:
in response to a summoning operation for the first virtual pet, trigger an interaction command for the first virtual pet; and
wherein the summoning operation is used for summoning the at least one second virtual pet to follow the first virtual pet, and the summoning operation is triggered by at least one of a summoning control, a joystick, a mouse, or a keyboard.

12. The device of claim 11, wherein the processor is further configured to:
in response to the interaction command for the first virtual pet, control the first virtual pet to summon the at least one second virtual pet; and
display a process of the at least one second virtual pet moving toward the first virtual pet during the first virtual pet summoning the at least one second virtual pet.

13. The device of claim 12, wherein the processor is further configured to:
display a virtual resource in a sealed state in the virtual scene;
in response to a movement operation for the first virtual pet, control the first virtual pet to move toward the virtual resource, and display a process of the at least one second virtual pet following a movement of the first virtual pet;
in response to the first virtual pet and the at least one second virtual pet moving to associated positions of the virtual resource, display a process of unsealing the virtual resource;
in response to unsealing of the virtual resource, display the virtual resource in an unsealed state; and
in response to a pick-up operation for the virtual resource in the unsealed state, control the first virtual pet to pick up the virtual resource.

14. The device of claim 10, wherein the virtual scene comprises at least two scene areas; the first virtual pet is located in a first scene area of the virtual scene; and the processor is further configured to:
in response to a movement command for the first virtual pet, control the first virtual pet to move from the first scene area to a second scene area of the virtual scene; wherein the second scene area comprises a third virtual pet of a different kind from the first virtual pet; and
in response to the first virtual pet being located in the second scene area, control a form of the first virtual pet to be transformed into the third virtual pet.

15. The device of claim 10, wherein the player character is located in a first virtual space in the virtual scene; and the processor is further configured to:
in response to a spatial teleportation command for the player character, teleport the player character from the first virtual space to a second virtual space of the virtual scene; and
in response to the player character being located in the second virtual space, trigger a transformation command for the player character.

16. The device of claim 10, wherein a faction to which the player character belongs further comprises at least one other virtual pet; and the processor is further configured to:
in response to a switching command for a target other virtual pet of the at least one other virtual pet, switch a control from the first virtual pet to the target other virtual pet; wherein the target other virtual pet is different from the first virtual pet in at least one of a form or attribute values;
wherein a second controlling module is further configured to: in response to an interaction command for the target other virtual pet, control the target other virtual pet to interact with the at least one second virtual pet.

17. The device of claim 10, wherein a number of first virtual pets to be transformed comprises at least one, and kinds of different first virtual pets are different; the processor is further configured to:
in response to a transformation command for the player character, display a plurality of pet options; wherein different pet options correspond to different kinds of the first virtual pets; and
in response to a selection operation for a target pet option of the plurality of pet options, transform the player character into the first virtual pet belonging to a target kind corresponding to the target pet option.

18. The device of claim 10, wherein the processor is further configured to:
in response to a fusion command for the first virtual pet, control the first virtual pet to fuse with the at least one second virtual pet, and display a fourth virtual pet obtained through the fusion; wherein, attribute values of the fourth virtual pet are higher than attribute values of the first virtual pet.

19. The device of claim 10, wherein the processor is further configured to:
display an attackable object; and
in response to an attack command for the first virtual pet, control the first virtual pet to attack the attackable object and display a process of the at least one second virtual pet attacking the attackable object.

20. A non-transitory computer-readable storage medium having stored thereon a computer program that when executed by a processor, implements a method for interaction in a virtual scene, wherein the method comprises:
displaying a player character in the virtual scene;
in response to a transformation command for the player character, controlling a form of the player character to be transformed into a first virtual pet;
displaying at least one second virtual pet of a same kind as the first virtual pet; and
in response to an interaction command for the first virtual pet, controlling the first virtual pet to interact with the at least one second virtual pet.
